(19) United States
(12) Patent Application Publication
(10) Pub. No.: US 2005/0263925 A1
(43) Pub. Date: Dec. 1, 2005

(54) Fire-resistant gypsum

(76) Inventors: Robert W. Heseltine, Guiseley (GB); J. H. B. Morelissen, Holland, OH (US)

Correspondence Address: OWENS CORNING, 2790 COLUMBUS ROAD, GRANVILLE, OH, 43023, US

(21) Appl. No.: 10/854,913

(22) Filed: May 27, 2004

(51) Int. Cl. B27N 3/00; D04H 1/00

(52) U.S. Cl. 264/109; 106/772

(57) ABSTRACT

An improved, fire-resistant, set gypsum composition contains set calcium sulfate dihydrate as the major ingredient and a reinforcing ingredient of resilient, flexible, boron-free glass fibers. Continuous filament forming glass compositions with a softening point preferably greater than about 1580° F. (about 860° C.) and more preferably greater than about 1681° F. (about 916° C.) may be used. The fibers typically are distributed as their separate constituent individual glass filaments uniformly throughout the set calcium sulfate dihydrate.

### TECHNICAL FIELD AND INDUSTRIAL APPLICABILITY OF INVENTION

This invention relates to improved fire-resistant gypsum and more particularly to fire-resistant set gypsum compositions containing high-softening-temperature, reinforcement glass fibers and filaments for use in such industrial applications as gypsum wallboard.

### BACKGROUND OF THE INVENTION

Gypsum is an important building commodity as evidenced by the hundreds of millions of square feet of gypsum-core wall board manufactured and sold yearly for use in the building industry. Gypsum wallboard, also commonly known as dry wall, gypsum board, gypsum sheathing, and plaster board, must have certain basic properties in order to meet accepted standards and pass industry-wide accepted tests. One or more of these tests relate to fire resistance, that is, either the maximum temperature a material can endure without burning through or collapsing (losing its integrity) or the time it takes at a certain high temperature to burn through, collapse, or otherwise destroy the integrity of the material. Fire resistance is to be distinguished from fire retardency which is the ability of a material to withstand high temperature and time without catching on fire and burning.

Fire-resistant, gypsum-core wallboard is an important factor in saving countless lives and preventing incalculable property losses as evidenced by the standards that have been set by governmental agencies, building code authorities, insurance companies, and builders and manufacturers' associations for the installation and performance of fire-resistant wallboard. In the interest of public safety, building codes require that fire-resistant construction assemblies of wallboard is often a component part that is installed in various parts of buildings and that the wallboard assembly pass standard and industry-wide accepted tests which are an evaluation of the fire resistance properties of the wallboard assembly. Fire insurance rates on buildings are influenced by the fire-resistant performance rating of wallboard assemblies installed in the building. Manufacturers of wallboard and builders associations have an interest in seeing that the public is provided with fire-resistant wallboard that meets accepted quality standards.

When exposed to intense heat, such as that generated by fire in a burning building, the wallboard, which is extensively used for constructing walls and ceilings, is expected to stay in place for some length of time and serve as an insulation barrier to deter the spread of fire. When subjected to standard fire-resistance tests which simulate conditions in a burning building, it is not unusual for commercially available fire-resistant wallboard to remain in place for 1 to 2 hours during which time it is exposed to temperatures as high as 1,850° F. (1010° C.). In order to perform in this manner, the wallboard core should resist to some degree its tendency to shrink and crack under the influence of heat because as it shrinks and cracks, it progressively pulls away from the supports to which it is fastened and eventually collapses.

In order to be commercially acceptable, fire-resistant wallboard must have satisfactory properties related to the manufacture, installation and service of the wallboard. For example, the aqueous slurry which contains the components comprising the core of the wallboard must be capable of being readily mixed and worked into a mass that can be continuously poured and formed into the set core. The core composition must be such that it forms a satisfactory bond with the facing that may cover the core. The finished product must have good flexibility, strength, fastener acceptance including nailability, and shock resistance.

Another important characteristic that commercially acceptable wallboard must have is that of a commercially acceptable thickness. This thickness generally ranges from about one-quarter inch to about one inch with the most popular thicknesses being about one-half inch and five-eighths inch. Whereas one or more of the above-mentioned properties of the wallboard, particularly the fire-resistant properties, may be improved by increasing the thickness of the core, such improvements are obtained at the expense of reducing or even losing other desirable properties. The commercially acceptable thickness range set forth above has been established after years of experience as the most desirable for gypsum-core wallboard.

In the past, there have been a series of important developments which have resulted in improvements in the fire-resistant properties of wallboard core. However, as will be seen from the discussion below, no progress has been made heretofore with respect to providing an improved glass-fiber composition for improving the fire-resistance of the gypsum wallboard core.

U.S. Pat. No. 2,681,863 to Croce and Shuttleworth discloses that the addition of drawn textile glass fibers to gypsum compositions imparts many desirable properties including fire-resistance. Short strands of drawn glass filaments, loosely bonded by a water soluble binder to form the fiber, are wet or dry mixed with calcium sulfate. An aqueous slurry composition is formed in which the filaments of the fibers readily and completely disperse upon dissolution of the binder. The dispersibility characteristic of the fiber filaments allows a gypsum composition to be made in which the filaments are individually and uniformly distributed throughout the composition thereby imparting to the composition desirable properties such as strength and fire resistance.

U.S. Pat. No. 3,616,173 to Green discloses a fire-resistant wallboard with improved fire-resistant properties in combination with low density properties. The composition comprises gypsum, glass fibers, and either clay, colloidal silica, or colloidal alumina or mixtures thereof. Unexpanded vermiculite can be added to improve the fire-resistant properties of the composition as unexpanded vermiculite expands when the core is heated and this expansion functions to offset the shrinkage of the gypsum component.

U.S. Pat. No. 4,195,110 to Dierks et al illustrates a gypsum board product in which long glass fibers are incorporated into the surface portion of the gypsum core for use in shaft walls, e.g., elevator shafts, air return shafts, and stairwells. The board is used without the usual paper covering to avoid smoke production on exposure to heat or fire.

U.S. Pat. No. 4,564,544 to Burkard et al details the use of feldspar-free muscovite in combination with glass fibers to improve the fire-resistance of wallboard. Feldspar-free muscovite undergoes 20% less shrinkage when heated than unexpanded vermiculite and thus is used to replace the vermiculite.

U.S. Pat. Nos. 4,664,707 and 4,722,866 to Wilson et al. discloses a fire-resistant gypsum composition obtained through the use of glass fibers, clay, and whisker fibers of water insoluble calcium sulfate.

U.S. Pat. No. 5,079,078 to Jutte, Jr. et al. is directed to a fire-resistant bulkhead panel formed by compression molding of fire-resistant skins to opposite sides of a core material such as gypsum which can be reinforced with glass fibers. The skins are formed from a prepreg of a high-softening temperature woven glass roving and a phenol-aldehyde resin and compression bonded to the gypsum core material. U.S. Pat. No. 5,148,645 to Lehnert et al. discloses an aqueous slurry of calcined gypsum and glass fibers that is fed onto a porous fiber-glass mat after which an overlying porous fiber glass mat is applied to the top surface of the poured gypsum slurry to form a mat-faced gypsum board.

U.S. Pat. Nos. 5,837,621 and 5,972,434 to Kajander disclose fire-resistant glass fibers in which the fibers are coated with a nitrogen-containing compound and a boron-containing compound. When the coated fiber is exposed to high temperatures, the boron and nitrogen react to form a boron nitride refractory material sheath around the fibers thereby increasing their fire resistance.

As is apparent from the above discussion, glass fibers have become a common ingredient in many set gypsum products. Such fibers are made from electrical glass (E-Glass) which has been the standard glass composition for making continuous glass fiber strands since the 1940's. The softening point of E-Glass is about 835° C. to about 860° C. (about 1535° F. to about 1580° F.). The fibers add a certain amount of structural integrity to the set gypsum composition and, as a result, a certain amount of fire-resistance due to the fact that the gypsum is less likely to crack, spall, and/or pull away from structural fasteners under conditions of high heat and fire. Although some effort has been made to improve the fire-resistance of the glass fibers themselves by applying and forming a fire-resistant ceramic coating on them, no effort has been made to find glass fibers with improved fire-resistant properties for use in set gypsum compositions.

As such, it is an object of the present invention to provide improved fire-resistant, set-gypsum, glass-fiber compositions.

It is an object of the present invention to provide glass compositions capable of forming glass filaments that improve the fire-resistance of set gypsum compositions.

It is an object of the present invention to save life and property through the use of a fiber-glass-containing, set-gypsum composition with improved fire resistance properties.

It is an object of the present invention to provide a glass-fiber set gypsum composition that has an improved capability of preserving its structural integrity under high temperature and fire conditions.

It is another object of this invention to provide an improved wallboard characterized by a gypsum core containing glass fibers with a glass composition having improved fire-resistant properties.

It is a further object of this invention to provide a fire-resistant, gypsum core wallboard with improved fire-resistant glass fibers that are capable of maintaining their integrity when subjected to high temperatures.

It is yet another object of this invention to provide a combination of set gypsum and glass fiber that has improved fire-resistant properties.

Another object of this invention is to provide a cost-effective method for improving the fire-resistant properties of set gypsum through the use of an improved, fire-resistant glass composition.

The foregoing and other objects, features and advantages of the invention will become apparent from the following disclosure in which one or more preferred embodiments of the invention are described in detail. It is contemplated that variations in procedures and product formulations may appear to a person skilled in the art without departing from the scope of or sacrificing any of the advantages of the invention.

### SUMMARY OF THE INVENTION

The above problems are solved and objects met by the present invention which features a set gypsum composition comprising set calcium sulfate dihydrate as the major ingredient and a reinforcing ingredient of resilient, flexible, glass fibers having a softening point greater than about. 1580° F. (860° C.) and distributed in the set calcium sulfate. Preferably the glass softening temperature of the glass fibers is at least about 1650° F. (899° C.). More preferably, it is at least about 1680° F. (916° C.). Most preferably, the glass fibers are essentially boron-free.

Such high-softening-point glass fibers have the advantage of providing a superior fire-resistant gypsum composition. Such compositions exhibit at least a third more glass retention at high temperatures than that of conventional glass fibers currently used in set gypsum compositions. This, in turn, results in a high composition integrity at these temperatures, that is, there is much less likelihood that the composition will collapse or otherwise fail under high temperature and fire conditions.

The set gypsum composition of the current invention can take on many forms. For example, it can be formed as a wallboard core of set calcium sulfate dihydrate (set gypsum) and sandwiched between two opposed porous faces formed of the high-softening-point glass fibers, e.g., woven or unwoven fiber glass mats, in which the set calcium sulfate dihydrate fills at least partially the voids of the porous glass-fiber faces. For situations where aesthetic appearance is of concern, the glass fibers can be completely embedded within the set gypsum.

Alternatively, the set gypsum composition can be formed in layers with the glass fibers distributed in at least some of the layers. Here, slurries of the preset gypsum have varying amounts of high-softening-point glass fibers incorporated into them. A first slurry with a high density of the high-softening-point glass fibers is poured as a first layer. As the first layer begins to set, a second slurry containing a lesser density of glass fibers or even no glass fibers at all is poured on the first layer. Finally, as the second layer begins to set, a third slurry (typically of the same high-softening-point glass fiber composition as the first slurry) is poured on to the second layer. The layered structure is then allowed to set and dry according to conventional processing.

In another embodiment of the invention, the individual glass filaments of glass fibers are bound together with water soluble or water-softening bonding materials that are sufficiently weakly bonded so as to separate and disperse into the individual glass filaments that form the fibers during the wet mixing of ingredients to form the preset gypsum slurry. As a result, the high-softening-temperature, glass-fiber filaments of the glass fibers are individually and uniformly distributed throughout the set gypsum (calcium sulfate dihydrate) composition.

The set gypsum composition can be formed as a wallboard core sandwiched between two opposed paper faces. Preferably the set gypsum composition contains about 5 to about 7 pounds (about 2.3 kg to about 3.2 kg) of high-softening-point glass fiber filaments per 1000 square feet (92.9 square meters) of the set gypsum composition. The filaments are about one-half of an inch long (1.27 cm) and have a diameter of about 16 microns. Alternatively, the set gypsum composition can be formed as a wallboard core sandwiched between two opposed fiber-glass mat faces formed from high-softening-point glass fibers.

In addition to calcined calcium sulfate (gypsum) and the high-softening-point glass fibers made from continuous drawn glass filaments, other optional ingredients can be added to the aqueous composition (slurry) used to form the set gypsum compositions. These optional additives include foaming agents to control the density of the set composition, dispersing agents to aid in dispersing the dry materials into the aqueous slurry, adhesives for more tightly binding the composition together, accelerators and retarders for controlling the time necessary for the slurry to form the set gypsum compositions, agents to resist water-degradation of the set gypsum, and other fire-resistant additives such as clay, colloidal silica, colloidal alumina, feldspar-free muscovite, unexpanded vermiculite, and water-insoluble calcium sulfate anhydrite whisker fibers.

A wide variety of glass compositions can be used for the current invention provided they have a softening point greater then about 1580° F. (860° C.), preferably at least about 1650° F. (900° C.) and more preferably at least about 1680° F. (916° C.). For processing ease, it is preferred that these glass compositions have a softening point less than about 1900° F. Most preferably the glass compositions are essentially boron-free, that is, free of boron containing compounds other than the trace impurities found in the glass forming materials. Further, all of these high-softening-point glass compositions must be capable of forming continuous glass filaments which are then gathered into glass fibers (roving or strands) and held together with a bonding or sizing agent. The following glass compositions are illustrative of various boron-free glass compositions contemplated by the present invention.

A glass-fiber filament composition that consists essentially of 59.0 to 62.0 weight percent SiO₂, about 20.0 to about 24.0 weight percent CaO, about 12.0 to about 15.0 weight percent Al₂O₃, about 1.0 to about 4.0 weight percent MgO, about 0.0 to about 0.5 weight percent F₂, about 0.1 to about 2.0 weight percent Na₂O, about 0.0 to about 0.9 weight percent TiO₂, about 0.0 to about 0.5 weight percent Fe₂O₃, about 0.0 to about 2.0 weight percent K₂O, and about 0.0 to about 0.5 weight percent SO₃. The difference between the forming temperature and the liquidus temperature (temperature above which no glass crystals can occur) of the glass fiber filaments is at least about 100° F. (38° C.). This difference is also referred to here as the delta T temperature. Glass compositions with lower delta T temperatures do not readily form filaments due to glass devitrification in the filament forming equipment. Such glass fiber compositions have a softening point between about 1550-1700° F. (843-927° C.). Preferably, such compositions typically will have a softening point in the range of above about 1580° F. (860° C.) to about 1700° F. (927° C.) with the high-softening point ranges being more preferred, e.g., about 1650° F. (899° C.) to about 1700° F. (927° C.). An even more preferred composition has a softening point range of about 1670° F. (910° C.) to about 1690° F. (921° C.).

Preferably the titania (TiO₂) content should not be more than about 0.6 weight percent and more preferably not more than about 0.4 weight percent and the magnesia (MgO) content should range from about 2.0 to about 3.5 weight percent. Most preferably and in addition to being essentially boron-free, it is preferred that this composition be essentially free of F₂, TiO₂, and SO₃.

A second glass composition consists essentially of about 59.0 to about 61.0 weight percent SiO₂, about 21.5 to about 22.5 weight percent CaO, about 12.7 to about 14.0 weight percent Al₂O₃, about 2.5 to about 3.3 weight percent MgO, about 0.1 to about 2.0 weight percent Na₂O and K₂O, and about 0.0 to about 0.6 weight percent TiO₂. Here, the difference between the forming temperature and the liquidus temperature of the glass fiber filaments is at least 125° F. (52° C.). More preferably, this composition is further limited as follows: the SiO₂ content is about 60.2 weight percent, the CaO content is about 22.0 weight percent, the Al₂O₃ content is about 13.2 weight percent, the MgO content is about 3.0 weight percent, and the combined Na₂O and K₂O content is about 0.8 weight percent.

In a most preferred glass composition, the SiO₂ content is about 60.1 weight percent, the CaO content is about 22.1 weight percent, the Al₂O₃ content is about 13.2 weight percent, the MgO content is about 3.0 weight percent, the K₂O content is about 0.2 weight percent, the Na₂O content is about 0.6 weight percent, the Fe₂O₃ content is about 0.2 weight percent, the combined content of SO₃ and F₂ content is about 0.1 weight percent, and the TiO₂ content is about 0.5 weight percent. The difference between the forming temperature and the liquidus temperature of the glass fiber filaments is at least about 150° F. (66° C.). Such a glass composition has a softening point of about 1681° F. (916° C.).

The set gypsum composition is made by mixing: 1) an aqueous solution of calcined calcium sulfate, 2) glass fibers having a high softening point, and 3) the optional additives noted above to form a slurry. All of the dry ingredients may be premixed prior to adding the liquid ingredients including water or both liquid and dry ingredients may be mixed in one operation. As noted above, the glass fibers should have a softening point greater than about 1580° F. (860° C.), preferably at least about 1650° F. (900° C.), and most preferably at least about 1680° F. (916° C.). For processing ease, these glasses should have a softening point below about 1900° F. (1038° C.) and typically below about 1700° F. (927° C.). Such high-softening-point glasses can be achieved with glass compositions that are essentially boron-free. For conventional wallboard formation, the individual glass filaments that form the glass fibers are bound together with water soluble or water-softening bonding materials with a sufficiently weak bond so that the individual glass filaments of the fiber separate and disperse during the mixing step.

After the slurry is formed, it is dispensed into a holding form. For wallboard production, the holding form is typically a facing paper or fiber glass mat that is bent upward at its edges to retain the dispensed slurry. Typically a second sheet of facing paper or fiber glass is placed on top of the dispensed slurry. The slurry is evenly distributed in the holding form, typically by rolling, and then allowed to set (harden) to form the set gypsum wallboard composition.

The mixing step may be carried out to afford two or more slurries. The first slurry comprises calcined gypsum and a high density of high-softening-point glass fibers, while the second slurry comprises calcined gypsum and optional high-softening-point glass fibers. The first slurry is dispensed as a first layer and prior to complete setting, the second slurry is dispensed as a second layer on top of the first layer. Prior to the complete setting of the second layer, the first slurry is dispensed as a third layer on top of the second layer. The layered gypsum composition is then processed in a conventional manner to complete the setting process.

The foregoing and other objects, features and advantages of the invention will become apparent from the following disclosure in which one or more preferred embodiments of the invention are described in detail and illustrated in the accompanying drawings. It is contemplated that variations in procedures, structural features and arrangement of parts may appear to a person skilled in the art without departing from the scope of or sacrificing any of the advantages of the invention.

In describing the preferred embodiment of the invention described below, specific terminology is resorted to for the sake of clarity. However, it is not intended that the invention be limited to the specific terms so selected and it is to be understood that each specific term includes all technical equivalents that operate in a similar manner to accomplish a similar purpose.

Although a preferred embodiment of the invention has been herein described, it is understood that various changes and modifications in the described structure can be affected without departure from the basic principles that underlie the invention. Changes and modifications of this type are therefore deemed to be circumscribed by the spirit and scope of the invention, except as the same may be necessarily modified by the appended claims or reasonable equivalents thereof.

### DETAILED DESCRIPTION OF THE INVENTION AND BEST MODE FOR CARRYING OUT THE PREFERRED EMBODIMENT

The present invention features a set gypsum composition comprising set calcium sulfate dihydrate as the major ingredient and a reinforcing ingredient of resilient, flexible, glass fibers that are essentially boron-free. Boron may be included in the glass composition but it is to be realized that boron typically lowers the glass-softening-point. Preferably, the individual filaments of the glass fiber are individually and uniformly distributed throughout the set calcium sulfate dihydrate composition.

Set calcium sulfate dihydrate (also referred to here as set gypsum or re-hydrated stucco) is the basic material used in gypsum structural products such as gypsum wallboard (also known as dry wall, gypsum board and gypsum sheathing) as well as in casts, molds, stucco work, and cements. The core of such a product is formed by mixing water with powdered calcium sulfate hemihydrate (CaSO₄.½H₂O), also known as calcined gypsum, and thereafter allowing the mixture to hydrate and set into calcium sulfate dihydrate (CaSO₄.2H₂O), a relatively hard material referred to here as set calcium sulfate dihydrate or set gypsum. The core of a typical gypsum wallboard product typically comprises at least about 85 weight percent of set gypsum. Other set gypsum products may have less gypsum depending on the additives present in the composition.

Typical glass filament glass compositions for the present invention are set forth in Table 1. The total of all the components of each of the compositions A-D, including any trace impurities, in the composition is 100 percent by weight. The glasses of composition A have a viscosity of about 1000 poise at temperatures ranging from about 2100° F. to about 2500° F. (about 1149° C. to about 1371° C.) which is also referred to as the log 3 temperature and is typically the “forming temperature” at which the glass filaments are formed. The liquidus temperature of the glass (the temperature at which no crystals can exist in the melt) must be at least about 100° F. (about 38° C.) below the temperature at which the filaments are formed to avoid de vitrification during the filament forming

TABLE 1
Boron-Free Glass Filament Compositions

| Component | A (wt %) | B (wt %) | C (wt %) | D (wt %) |
|---|---|---|---|---|
| SiO₂ | 59.0-62.0 | 59.0-61.0 | 59.5-60.5 | 60.1 |
| CaO | 20.0-24.0 | 21.5-22.5 | 21.7-22.3 | 22.1 |
| Al₂O₃ | 12.0-15.0 | 12.7-14.0 | 13.0-13.5 | 13.2 |
| MgO | 1.0-4.0 | 2.5-3.3 | 2.7-3.3 | 3.0 |
| F₂ | 0.0-0.5 | | | |
| Na₂O | 0.1-2.0 | | | 0.6 |
| TiO₂ | 0.0-0.9 | 0.0-0.6 | | 0.5 |
| Fe₂O₃ | 0.0-0.5 | | | 0.2 |
| K₂O | 0.0-2.0 | | | 0.2 |
| SO₃ | 0.0-0.5 | | | |
| Na₂O + K₂O | | 0.1-2.0 | 0.5-1.0 | |
| SO₃ + F₂ | | | | 0.1 |

operations. Despite their high-temperature operating conditions, these glasses can be fiberized without devitrification in the bushing or at forming because of this difference in temperature between the forming temperature and the liquidus temperature. This difference in forming and liquidus temperature is referred to as the forming-liquidus temperature difference “delta T” or “T”. As noted above, the delta T temperature must be at least about 100° F. (about 38° C.), preferably about 125° F. (about 52° C.), and most preferably about 150° F. (about 66° C.). It is to be realized that not all high-temperature glass compositions have such a delta T and thus are not suitable for the formation of continuous drawn glass filaments. These glasses have a softening-point range of about 1550-1700° F. (about 843-927° C.) with glasses with a softening-point range of about 1580-1700° F. (about 860-927° C.) being preferred. More preferred are glass compositions having a softening point range of about 1650-1700° F. (about 899-927° C.) with the most preferred range being about 1670-1690° F. (about 910-921° C.). These compositions are all boron-free.

In a preferred embodiment of composition A, the weight percent of MgO ranges from about 2.0 to about 3.5. In an especially preferred embodiment of composition A, the TiO₂ content is not more than about 0.6 weight percent and more preferably not more than about 0.04 weight percent. In an additional preferred embodiment of embodiment A, the TiO₂ content is not more than about 0.6 weight percent and the F₂ content is essentially zero.

Another preferred embodiment is that of composition B. The viscosity of the glasses of composition B are about 1000 poise at temperatures ranging from about 2200° F. to about 2400° F. (about 1204° C. to about 1316° C.) and the liquidus temperatures of these glasses are at least about 125° F. (about 52° C.) below the temperature for a viscosity of about 1000 poise, that is, delta T is at least about 125° F. (about 52° C.). Another more preferred embodiment is that of composition C.

An especially preferred embodiment is that of composition D. The glass has temperature characteristics on the order of log 3 of about 2300° F. (about 1260° C.), a liquidus temperature of about 2200° F. (about 1200° C.), and a delta T of about 150° F. (about 66° C.). Such a glass also has the following properties: density (of fiber; according to ASTM D1505) of about 2.62 g/ml; tensile strength at 23° C. (of pristine, unsized laboratory-produced single fiber; ASTM D2101) of about 3100 to about 3800 MPa (about 450 to about 550 kpsi); elastic modulus (sonic method) of about 80 to about 81 GPa (Mpsi); elongation at breaking (of pristine, unsized laboratory-produced single fiber; ASTM D2101) of about 4.6%; refractive index (of pristine, unsized laboratory-produced single fiber; oil immersion) of about 1.560 to about 1.562; thermal linear expansion at 0 to about 300° C. (of bulk annealed glass; ASTM D696) of about 6.0 ppm/° C.; softening point (ASTM C338) of about 1681° F. (about 916° C.); annealing point (ASTM C336) of about 736° C.; strain point (ASTM C336) of about 691° C.; dielectric constant at 23° C. and 1 MHz (of bulk annealed glass; ASTM D150) of about 7.0; dissipation factor at 23° C. and 1 MHz (of bulk annealed glass; ASTM D150) of about 0.001; volume resistivity (of bulk annealed glass; ASTM D257; extrapolated from measurements at elevated temperatures, about 120 to about 500° C., based on log resistivity=A/temperature+B) of about 8.1×10²⁶; dielectric strength at 4.8 mm thickness (of bulk annealed glass; ASTM D149) of about 8 kV/mm; percentage of original tenacity after exposure to 5% NaOH at 23° C. for 28 days (of pristine, unsized laboratory-produced single fiber) of about 30.

Regardless of the remaining ingredient composition as set forth above in A-D, it is preferred to have a MgO content ranging from about 2.0 to about 3.5 weight percent of the total composition. Similarly the TiO₂ (titania) composition is preferably less than about 0.6 weight percent and more preferably not more than about 0.4 weight percent of the total composition. It is preferred that the sulfate, fluorine, and titania contents each be essentially zero. Finally, it is most preferred that all of the above glass compositions be essentially free of a boron.

Generally it is to be realized the removal of boron from a glass composition tends to elevate the softening point of the glass. As such, the boron-free glass compositions noted above have a softening point above that of typical borosilicate glass counterpart, such as the E-Glass routinely used in the manufacture of drawn, continuous filaments used in the production of glass fibers. E-Glasses have a softening point in the range of about 1535 to about 1580° F. (about 835 to about 860° C.) with standard commercial products having a softening point of about 1555° F. (about 846° C.).

For the purposes of the present invention, the term “high-softening-point glass fiber or filament” refers to a fiber or filament with a softening point greater than about 1555° F. (about 846° C.), preferably greater than about 1580° F. (about 860° C.), more preferably greater than about 1650° F. (about 900° C.), and more preferably equal to or greater than about 1680° F. (about 915° C.), the final cited temperature being about 100° F. above the upper range limit of E-Glass compositions. The softening point temperatures noted refer to the softening point of the glass fibers and filaments prior to placement within the set gypsum composition.

It is possible to achieve an even higher softening point through the use of S-Glasses which have a typical softening point of about 1935° F. (about 1057° C.). A typical S-Glass has a composition of about 65 weight % silica, about 25 weight % alumina, and about 10 weight % magnesia. These glasses are quite costly and, as such, are not typically used in gypsum compositions. It is also to be realized that it is possible for any of the above glass filament compositions to contain some boron as long as the noted high-temperature softening points are achieved. However, boron is typically to be avoided as it tends to lower the softening point. In addition, materials such as boron, fluorine and SO₃ are volatile components that contribute to evolved emissions from the glass melting operation and preferably are kept to minimal levels.

Continuous glass filaments are formed by feeding molten glass from a forehearth into a bushing and though orifices (tips) and attenuating the filaments. U.S. Pat. Nos. 5,055,119; 4,846,865; and 5,312,470 are representative of the current technology and are incorporated here by reference as if completely written herein. A protective coating and bonding agent (sizing) is applied to the individual filaments after which they are gathered together to form the roving which is here referred to as the fiber or strand, and wound on winding drums. In some cases, the sizing is of such a character as to permanently hold the filaments of the fiber together. However and typically, the filaments of the fibers for the current gypsum composition are loosely bonded or associated by a bonding material that is water softenable or water soluble in character. Starch is a common sizing agent used with glass fibers to be incorporated into a gypsum composition although other water softenable or water soluble resins are used. A proprietary binder containing aminosilane and cationic lubricants is commercially available with continuous glass, chopped strands from Owens Corning (Toledo Ohio) as chemical size 790A.

As used here, the terms strands, roving, and fiber refer to the basic glass textile units that are used in the manufacture of glass textiles. Each such unit is comprised of a multiplicity of individual components of the fiber and is denoted here by the term “filament(s)”. That is, individual glass fibers (or strands or rovings) each consist of hundreds of individual continuously-drawn, glass filaments.

In the conventional process for preparing gypsum compositions, short lengths of glass fiber are added to and mixed with the calcined gypsum slurry. Because a water soluble or softenable sizing has been used to bind the filaments into fibers, the action of the water in the slurry dissolves or softens the sizing to such an extent that the individual glass filaments of the fiber dissociate from each other and are completely dispersed and individually and uniformly distributed throughout the slurry in a random relation of the individual fibers with each other. This random relation and uniform distribution remains throughout the set gypsum product.

For use in gypsum wallboard compositions, the fibers are cut into short lengths in the range of about ⅛ inch to about 1 inch (about 0.3 cm to about 2.5 cm). Preferably the length is about ½ inch (about 1.3 cm) as this provides the most effective size for wallboard strength, flexibility, and fire resistance including resistance to cracking while allowing for easy breaking by cutting the paper cover along a straight line and breaking along the line. In some instances where flexural strength is needed, such as for shaft walls, e.g., elevator and air shafts, longer strands, e.g., about 9 inches in length (about 22.9 cm), may be used. Fiber filaments range from about 0.00015 to about 0.001 inch (about 3.8 cm to about 25 cm) in diameter. Preferably, the filament diameter should be about 16 cm (about 0.00063 in) in diameter.

For wallboard core compositions, the glass composition ranges from about 0.5 to about 16 pounds of glass filament per 1000 square feet of set gypsum composition, often designated as 0.5-20 pounds/M square feet (or MSF) where M is the Roman numeral for thousand. Below about 0.5 pounds/MSF (0.23 kg/92.9 m²), the glass filament has too little effect on the composition while above about 16 pounds/MSF (about 7.3 kg/92.9 m²), the filaments tend to clump rather than being distributed randomly as single filaments throughout the set gypsum composition. Typically about 5 to about 7 pounds (about 2.3 to about 3.2 kg) of glass filament is used per 1000 square feet (92.9 m²) of set gypsum composition. On a weight percentage basis, the glass fiber content is about 0.25 to about 0.35 wt. % of the total set gypsum composition assuming a total set gypsum composition of about 2000 pounds (907 kg) per 1000 square feet (92.9 m²).

In some applications, two layers of a high density glass fiber gypsum composition can be used to sandwich a low-density glass-fiber gypsum composition. Here many of the fibers remain in tact, i.e., in a mat-type arrangement. In such instances from about 2 to about 10 weight percent of the total dry slurry ingredients are in the form of glass fibers. Above about 10 wt. % of fiber on a dry ingredient basis, the gypsum slurry becomes too hard to mix. About 6.7 weight percent of glass fiber (on a total dry ingredient basis) can be used.

Also contemplated by the present invention is an embodiment in which a porous, high-softening-point glass fiber mat in either woven or non-woven form is substituted for the conventional paper facing used in standard wallboard. Here the gypsum slurry, with or without glass fibers, penetrates and fills the voids in the porous glass fiber mat comprised of glass fibers in either woven or non-woven form. It is essential to point out that the glass fibers form an integral part of the set gypsum composition and are intermixed at least partially, and often fully, with the calcium sulfate dihydrate of the set gypsum composition as contrasted to those situations in which the glass fibers are applied to the surfaces of previously set gypsum composition by means of adhesives and resins.

A wide variety of additives can be added to the slurry of calcined calcium sulfate and glass fibers in order to affect the processing characteristics of the slurry and/or the characteristics of the set gypsum composition. Such additives include foaming agents, dispersing agents, accelerators, retarders, adhesives, agents to resist water-degradation of the set gypsum, and other fire-resistant additives such as clay, colloidal silica, colloidal alumina, feldspar-free muscovite, unexpanded vermiculite, and water-insoluble calcium sulfate anhydrite whisker fibers.

Foaming agents such as ammonium or sodium lauryl sulfonate are used to control the density of the set gypsum composition. A dilute aqueous solution of the foaming agent is added to the slurry and foamed by agitation or by passing pressurized air through the slurry. For typical wallboard application, the set gypsum composition has a density that ranges from about 35 to about 75 pounds/cubic foot (about 15.9 to about 34.0 kg/0.0283m³). Typically, the gypsum composition becomes to porous below about 35 pounds/cubic foot (about 15.9 kg/0.0283 m³) and problems are encountered with obtaining good adhesion to the typical paper facing. Above about 50 pounds/cubic foot (about 22.7/0.0283 m³), handling issues including worker fatigue can become a problem.

Unexpanded vermiculite can be added to the gypsum composition in order to compensate for gypsum shrinkage as it is heated and its combined water lost. The quality, quantity and particle size of the unexpanded vermiculite should be such that it expands to equal the gypsum shrinkage. Typically vermiculite is used in amounts up to about 7.5 weight percent of the set gypsum composition with preferred amounts ranging from about 1.0 to about 3.5 weight percent. Smaller amounts of feldspar-free muscovite can be used in place of unexpanded vermiculite with similar results.

Clay, colloidal silica, and colloidal alumina alone or in combination can be added to the gypsum composition to improve its strength and reduce its tendency to shrink at high temperatures. The total amount of these ingredients ranges from about 0.5 to about 20.0 weight percent of the total dry ingredients used to form the gypsum slurry. Preferably about 2.0 to about 5.0 weight percent of these materials are used. Water-insoluble calcium sulfate anhydrite whisker fibers may also be used in an amount ranging from about 0.1 to about 2.0 weight percent of the total weight of the dry ingredients used to form the settable slurry. Preferably about 0.4 to about 1.0 weight percent is used.

For set gypsum compositions that may be exposed to damp environments, agents to resist water-degradation may be added to the set gypsum composition. Such agents include, but are not limited to, materials such as poly(vinyl) alcohol with or without poly(vinyl acetate), wax and/or asphalt with or without materials such as potassium sulfate, alkali and alkaline earth aluminate, and Portland cement, metallic resinates, and organohydrogenpolysiloxanes.

Dispersing agents such as calcium lignosuflonate can be used to help disperse the dry ingredients into the settable slurry. Set accelerators and retarders are used to obtain a desired slurry setting time, typically about five minutes. A typical set accelerator is potash (potassium carbonate) while set retarders include such materials as magnesium oxide, zinc oxide, calcium carbonate, magnesium carbonate, zinc sulfate, and zinc stearate. Viscosity control agents such as paper fiber, cellulosic thickeners, bentonite clays, starches, and gypsum whisker fibers may be used to control the viscosity of the slurry. This can be especially useful in applications where the calcined calcium sulfate slurry is used to fill the voids of a fiber-glass mat facing material. For such applications, the viscosity of the slurry is adjusted to about 5000-7000 cp. Core adhesives such as gelatinized starch may be used in amounts of up to about 1 weight percent of the combined dry ingredients to improve particle adhesion.

To make a set gypsum composition according tot he present invention, dry ingredients including calcined calcium sulfate, glass fibers with a high softening point, e.g., greater than about 1555° F. (about 846° C.), preferably greater than about 860° F. (about 860° C.) and more preferably greater than about 1650° F. (about 899° C.), and optional additives from which a typical gypsum wallboard core is formed are pre-mixed and then fed to a mixer of the type commonly referred to as a pin mixer. Water and other liquid constituents used in making the core are metered into the pin mixer where they are combined with the dry ingredients to form an aqueous gypsum slurry. Optionally, all ingredients may be mixed in a single mixer without a dry ingredient premixing step. For conventional wallboard, glass fibers with a water-soluble or water softenable binding are mixed sufficiently in the aqueous slurry to dissociate the individual filaments and distribute them individually and uniformly throughout the slurry.

Foam is generally added to the slurry in the pin mixer to control the density of the resulting core. The slurry is dispersed through one or more outlets at the bottom of the mixer onto a moving paper facing sheet. The sheet is indefinite in length and is fed from a roll. The opposite edge portions of the paper sheet are progressively flexed upwardly from the mean plane of the paper and then turned inwardly at the margins so as to provide coverings for the edges of the resulting board. Another paper facing sheet is fed from a roll onto the top of the slurry thereby sandwiching the slurry between the two moving paper sheets. As used here, facing sheet refers to materials applied to both the front and back (top and bottom) of the gypsum core composition.

The two paper sheets with the slurry sandwiched between enter upper and lower forming rolls to distribute the slurry to an even thickness after which the sheets and distributed slurry are received on a conveyer belt. Conventional edge guiding devices shape and maintain the edges of the composite until the gypsum has set sufficiently to retain its shape. In due course, sequential lengths of the board are cut and further processed by exposure to heat which accelerates the drying of the board by increasing the rate of evaporation of excess water in the gypsum slurry. In this embodiment, the glass fibers are mixed sufficiently in the slurry to distribute the filaments of the glass fibers individually and uniformly throughout the slurry.

In an alternate embodiment, porous fiber glass mats with “high softening point” (greater than about 1555° F. (about 846° C.), preferably greater than about 1580° F. (about 860° C.) and more preferably greater than about 1650° F. (about 899° C.)), woven or non-woven fibers are used in place of the paper facing sheets. The gypsum slurry may or may not contain high-softening-point glass fibers and is of such viscosity so as to allow it to penetrate into the open pores of the fiber-glass mats.

Preferably, the gypsum slurry penetrates completely through the mat and coats the glass fibers on the outer surface of the fiber glass mats with a thin film of set gypsum. However, depending on the end use of the wallboard, such complete coverage of the outer surface of one or both of the two facing mats may not be necessary but rather only that a portion of the fibers of the mats become an integral part of the calcium sulfate dihydrate of the set gypsum composition.

In yet another embodiment, two slurries are made, the first having a high density of high-softening point glass fibers (about 2 to about 10 weight percent of the dry ingredients) while the second has a lower or even no high-softening point glass fiber content. A first layer of the high-density glass fiber slurry is formed and prior to set, a second layer of the low or no high-softening point glass is formed on top of the first layer. This is followed by a third layer of the high-density glass fiber slurry formed on top of the second layer prior to its set. Once the layers are set, the resulting composition is dried and processed according to conventional wallboard processing to produce a wall board without paper facing but rather with a gypsum interior core with or without glass fibers and two outer core layers with a high-density of high-softening point glass fibers. Preferably the interior core also contains a low density of high-softening point glass fiber filaments randomly dispersed but traditional fibers or even no fibers may be used. Such a wallboard composition has no paper facing and thus is much less likely to smoke under conditions of high heat or flame. U.S. Pat. Nos. 5,148,645 and 4,195,110 are incorporated here by reference as if completely written herein and detail more fully gypsum board manufacture.

Finally, it is to be realized that it is possible that changes in configurations to other than those shown could be used but that which is shown is preferred and typical. Without departing from the spirit of this invention, various high-softening-temperature glasses capable of forming continuous filaments maybe used including those with boron content although as noted, boron-free compositions are preferred. It is therefore understood that although the present invention has been specifically disclosed with the preferred embodiment and examples, modifications to the design concerning the form of the final set gypsum composition, facing materials or lack thereof, layered gypsum compositions with varying amounts of high-softening point glass fibers in the layers, and their size, shape, composition and arrangement will be apparent to those skilled in the art and such modifications and variations are considered to be equivalent to and within the scope of the disclosed invention and the appended claims.

The present set gypsum composition invention may suitably comprise, consist of, or consist essentially of integrally combined set calcium sulfate dihydrate and high-softening-point glass filaments. The high-softening-point fibers or filaments or both may be contained partially or fully within the set calcium sulfate dihydrate component of the set gypsum composition. Generally higher-softening-point glasses are preferred, typically with softening points greater than about 1555, about 1580, about 1650, and about 1680° F. (about 846, about 860, about 899, and about 916° C., respectively). Glasses with softening points less than about 1900° F. (about 1038° C.) and even less than about 1700° F. (about 927° C.) are more desirable due to present cost and processing considerations for such high-processing temperature glasses. For boron-free glasses, softening points in the range of about 1550 to about 1900, about 1580 to about 1900, about 1650 to about 1700, and about 1670 to about 1690° F. (about 846 to about 1038, about 860 to about 1038, about 899 to about 927, and about 910 to about 921° C., respectively) are increasing preferred. The invention disclosed herein suitably may be practiced in the absence of any element which is not specifically disclosed herein.

1. A set gypsum composition comprising:
set calcium sulfate dihydrate and reinforcing, individual glass fiber filaments having proved fire resistance, wherein said glass fiber filaments are essentially boron-free and are individually and uniformly distributed throughout said set calcium sulfate dihydrate, and wherein the glass softening temperature of said glass fiber filaments is greater than about 860° C.

2. The set gypsum composition according to claim 1, wherein said glass fiber filaments consist essentially of about 59.0 to about 62.0 weight percent SiO₂, about 20.0 to about 24.0 weight percent CaO, about 12.0 to about 15.0 weight percent Al₂O₃, about 1.0 to about 4.0 weight percent MgO, about 0.0 to about 0.5 weight percent F₂, about 0.1 to about 2.0 weight percent Na₂O, about 0.0 to about 0.9 weight percent TiO₂, about 0.0 to about 0.5 weight percent Fe₂O₃, about 0.0 to about 2.0 weight percent K₂O, and about 0.0 to about 0.5 weight percent SO₃.

3. The set gypsum composition according to claim 2, wherein said glass softening temperature of said glass fiber filaments is from about 860° C. to about 927° C.

4. The set gypsum composition according to claim 2, wherein said glass softening temperature of said glass fiber filaments is from about 899° C. to about 927° C.

5. The set gypsum composition according to claim 2, wherein said glass softening temperature of said glass fiber filaments is from about 910° C. to about 921° C.

6. The set gypsum composition according to claim 1, wherein said glass fiber filaments consist essentially of about 59.0 to about 61.0 weight percent SiO₂, about 21.5 to about 22.5 weight percent CaO, about 12.7 to about 14.0 weight percent Al₂O₃, about 2.5 to about 3.3 weight percent MgO, about 0.1 to about 2.0 weight percent Na₂O and K₂O and about 0.0 to about 0.6 weight percent TiO₂.

7. The set gypsum composition according to claim 1, wherein said glass fiber filaments are essentially free of a moiety selected from the group consisting of F₂, TiO₂, SO₃and combinations thereof.

8. The set gypsum composition according to claim 1 wherein in said glass fiber filaments the SiO₂ content is about 60.2 weight percent, the CaO content is about 22.0 weight percent, the Al₂O₃ content is about 13.2 weight percent, the MgO content is about 3.0 weight percent, and the combined Na₂O and K₂O content is about 0.8 weight percent.

9. The set gypsum composition according to claim 1 wherein in said glass fiber filaments the SiO₂ content is about 60.1 weight percent, the CaO content is about 22.1 weight percent, the Al₂O₃ content is about 13.2 weight percent, the MgO content is about 3.0 weight percent, the K₂O content is about 0.2 weight percent, the Na₂O content is about 0.6 weight percent, the Fe₂O₃ content is about 0.2 weight percent, the combined content of SO₃ and F₂ content is about 0.1 weight percent, and the TiO₂ content is about 0.5 weight percent.

10. The set gypsum composition according to claim 9, wherein said glass softening temperature of said glass fiber filaments is about 916° C.

11. (canceled)

12. The set gypsum composition according to claim 1, wherein said glass softening temperature of said glass fiber filaments is at least about 899° C.

13. The set gypsum composition according to claim 1, wherein said glass softening temperature of said glass fiber filaments is at least about 916° C.

14. The set gypsum composition according to claim 1, wherein said set gypsum composition is formed as a wallboard core having about 2.3 kg to about 3.2 kg of said glass fiber filaments per 92.9 square meters of said set gypsum composition with said glass fiber filaments being about 1.3 cm in length and about 16 microns in diameter.

15. The set gypsum composition according to claim 1, wherein said set gypsum composition is formed as a wallboard core sandwiched between two opposed paper faces.

16. The set gypsum composition according to claim 1, wherein said set gypsum composition is formed as a wallboard core sandwiched between two opposed glass fiber faces.

17. The set gypsum composition according to claim 1, wherein said set gypsum composition is prepared from an aqueous slurry comprising calcined calcium sulfate, glass fibers, and optional additives selected from the group consisting of foaming agents, dispersing agents, accelerators, adhesives, retarders, agents to resist water-degradation of the set gypsum, clay, colloidal silica, colloidal alumna, feldspar-free muscovite, unexpanded vermiculite and water-insoluble calcium sulfate anhydrite whisker fibers.

18. A set gypsum composition comprising:
set calcium sulfate dihydrate and reinforcing glass fibers having improved fire resistance ad a softening temperature greater than about 860° C. and distributed in said set calcium sulfate dihydrate.

19. The set gypsum composition according to claim 18, wherein said glass softening temperature of said glass fibers is at least about 899° C.

20. The set gypsum composition according to claim 18, wherein said glass softening temperature of said glass fibers is from about 899° C. to about 1038° C.

21. The set gypsum composition according to claim 18 wherein said glass fibers are essentially boron-free.

22. The set gypsum composition according to claim 18, wherein said set gypsum composition is formed as a wallboard core comprising set calcium sulfate dihydrate sandwiched between two opposed porous faces formed of said glass fibers, wherein said set calcium sulfate dihydrate at least partially fills the voids of said glass-fiber faces.

23. The set gypsum composition according to claim 18, wherein said set gypsum composition is formed in layers with said glass fibers distributed in at least some of said layers.

24. The set gypsum composition according to claim 18, wherein said glass fibers comprise glass fiber filaments, said glass fiber filaments being individually and uniformly distributed throughout said set calcium sulfate dihydrate.

25. The set gypsum composition according to claim 24, wherein said set gypsum composition is formed as a wallboard core sandwiched between two opposed paper faces.

26. The set gypsum composition according to claim 24, wherein said set gypsum composition is formed as a wallboard core sandwiched between two opposed fiber-glass mat faces formed from said glass fibers.

27. The set gypsum composition according to claim 18, wherein said set gypsum composition is prepared from an aqueous composition comprising calcined calcium sulfate glass fibers, and optional additives selected from the group consisting of foaming agents, dispersing agents, adhesives, accelerators, retarders, agents to resist water-degradation of the set gypsum, lay, colloidal silica, colloidal alumina, feldspar-free muscovite, unexpanded vermiculite and water-insoluble calcium sulfite anhydrite whisker fibers.

28-36. (canceled)

37. A fire resistant gypsum wallboard comprising:
a core layer having a first major surface and a second major surface, said core layer including set calcium sulfate dehydrate and essentially boron-free glass filaments having a glass softening temperature greater than about 846° C.;
a first external layer positioned on said first major surface; and
a second external layer positioned on said second major surface, said core layer being sandwiched between said first and second external layers.

38. The fire resistant gypsum wallboard of claim 37, wherein said first and second external layers are a member selected from the group consisting of a paper facing, a porous non-woven high soft point glass fiber mat and a porous woven high softening point glass fiber mat.

39. The fire resistant gypsum wallboard of claim 38, wherein at least one of said first and second external layers is a member selected from the group consisting of said porous non-woven glass fiber mat and said porous woven glass fiber mat, and wherein said set calcium sulfate dehydrate and said glass filaments at least partially fills voids present in said porous non-woven glass fiber mat and said porous woven glass fiber mat.

40. The fire resistant gypsum wallboard of claim 38, wherein said glass filaments are individually and uniformly distributed throughout said core layer.

41. The fire resistant gypsum wallboard of claim 40, wherein said glass fiber filaments are present in said core layer in an amount of from about 0.23 to 7.3 kg per 92.9 m² of set calcium sulfate dehydrate.

42. The fire resistant gypsum wallboard of claim 37, wherein said core layer comprises at least about 85% by weight of set calcium sulfate dehydrate.

43. The gypsum wallboard of claim 37, wherein the glass filaments have a delta T of at least about 38° C.

44. The gypsum wallboard of claim 37, wherein said glass filaments are boron-free.

45. The gypsum wallboard of claim 44, wherein said glass filaments comprise about 59.0 to about 62.0 weight percent SiO₂, about 20.0 to about 24.0 weight percent CaO, about 12.0 to about 15.0 weight percent Al₂O₃, about 1.0 to about 4.0 weight percent MgO, about 0.0 to about 0.5 weight percent F₂, about 0.1 to about 2.0 weight percent Na₂O, about 0.0 to about 0.9 weight percent TiO₂, about 0.0 to about 0.5 weight percent Fe₂O₃, about 0.0 to about 2.0 weight percent K₂O, and about 0.0 to about 0.5 weight percent SO₃.
